(19) United States
(12) Patent Application Publication
(10) Pub. No.: US 2015/0371662 A1
(43) Pub. Date: Dec. 24, 2015

(54) VOICE PROCESSING DEVICE AND VOICE PROCESSING METHOD

(71) Applicant: FUJITSU LIMITED, Kawasaki-shi (JP)

(72) Inventors: TARO TOGAWA, Kawasaki (JP); Chisato Shioda, Kawasaki (JP); Takeshi OTANI, Kawasaki (JP)

(73) Assignee: FUJITSU LIMITED, Kawasaki-shi (JP)

(21) Appl. No.: 14/723,907

(22) Filed: May 28, 2015

(30) Foreign Application Priority Data
Jun. 20, 2014 (JP) 2014-126828

(51) Int. Cl. G10L 25/18; G10L 15/04

(52) U.S. Cl. CPC G10L 25/18; G10L 15/04

(57) ABSTRACT

A voice processing device includes a memory; and a processor configured to execute a plurality of instructions stored in the memory, the instructions includes acquiring a transmitted voice; first detecting a first utterance segment of the transmitted voice; second detecting a response segment from the first utterance segment; determining a frequency of the response segment included in the transmitted voice; and estimating an utterance time period of a received voice on a basis of the frequency.

### CROSS-REFERENCE TO RELATED APPLICATION

This application is based upon and claims the benefit of priority from the prior Japanese Patent Application No. 2014-126828 filed on Jun. 20, 2014, the entire contents of which are incorporated herein by reference.

### FIELD

The embodiments discussed herein are related to a voice processing device, a voice processing method, a voice processing program and a portable terminal apparatus, for example, for estimating an utterance time period.

### BACKGROUND

Recently, together with the development of information processing apparatus, a scene that conversation is performed through a conversation application installed, for example, in a portable terminal or a personal computer has been and is increasing. When oneself and other party talk, smooth communication can be implemented by proceeding with a dialog while understanding thinking of each other. In this case, in order for oneself to understand the thinking of the other party, it is considered important for oneself to sufficiently listen to the utterance of the other party without unilaterally continuing the utterance. A technology for detecting utterance time periods of oneself and other party with a high degree of accuracy from input voices is demanded in order to grasp whether or not smooth communication is implemented successfully. For example, by detecting utterance time periods of oneself and other party, it can be determined whether or not the discussion is being conducted actively by both of oneself and the other party. Further, by such detection, it is possible in learning of a foreign language to determine whether or not a student understands the foreign language and speaks actively. In such a situation as described above, for example, International Publication Pamphlet No. WO 2009/145192 discloses a technology for evaluating signal quality of an input voice and estimating an utterance temporal segment on the basis of a result of the evaluation.

### SUMMARY

In accordance with an aspect of the embodiments, a voice processing device includes a memory; and a processor configured to execute a plurality of instructions stored in the memory, the instructions includes acquiring a transmitted voice; first detecting a first utterance segment of the transmitted voice; second detecting a response segment from the first utterance segment; determining a frequency of the response segment included in the transmitted voice; and estimating an utterance time period of a received voice on a basis of the frequency.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

These and/or other aspects and advantages will become apparent and more readily appreciated from the following description of the embodiments, taken in conjunction with the accompanying drawing of which:

FIG. 1 is a functional block diagram of a voice processing device according to a first embodiment;

FIG. 2 is a flow chart of a voice processing method by a voice processing device;

FIG. 3 is a functional block diagram of a detection unit according to one embodiment;

FIG. 4 is a view depicting a result of detection of an utterance temporal segment and an unvoiced temporal segment by a detection unit;

FIG. 5 is a view depicting a result of determination of appearance of a response segment by a determination unit;

FIG. 6 is a diagram depicting a relationship between a frequency of a back-channel feedback of a first user and an utterance time period of a second user;

FIG. 7A is a diagram depicting a first relationship between a frequency and an estimated utterance time period of a reception voice;

FIG. 7B is a diagram depicting a second relationship between a frequency and an estimated utterance time period of a reception voice;

FIG. 8 is a diagram depicting a third relationship between a frequency and an estimated utterance time period of a reception voice;

FIG. 9 is a functional block diagram of a voice processing device according to a second embodiment;

FIG. 10 is a conceptual diagram of an overlapping temporal segment within an utterance temporal segment of a reception voice;

FIG. 11 is a block diagram depicting a hardware configuration that functions as a portable terminal device according to one embodiment; and

FIG. 12 is a block diagram depicting a hardware configuration of a computer that functions as a voice processing device according to one embodiment.

### DESCRIPTION OF EMBODIMENTS

In the following, working examples of a voice processing device, a voice processing method, a voice processing program and a portable terminal apparatus according to one embodiment are described in detail with reference to the drawings. It is to be noted that the working examples do not restrict the technology disclosed herein.

### Working Example 1

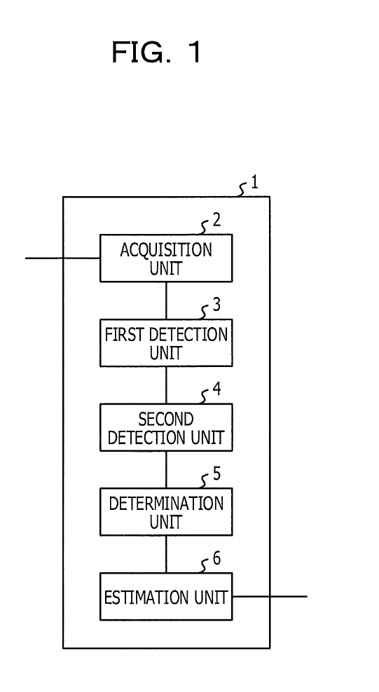

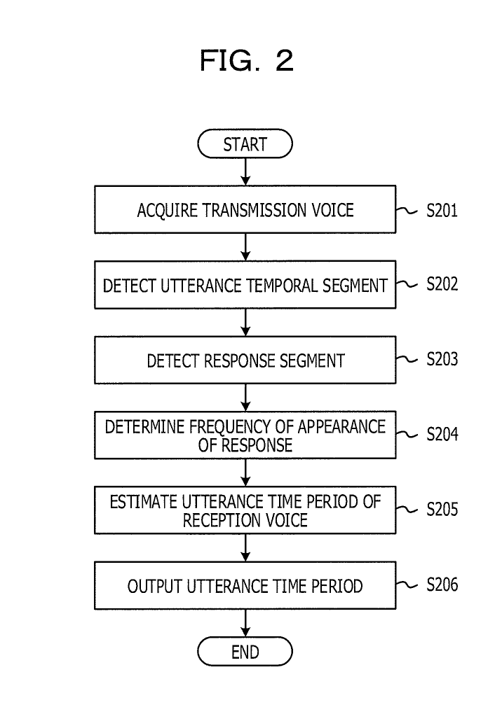

FIG. 1 is a functional block diagram of a voice processing device according to a first embodiment. A voice processing device 1 includes an acquisition unit 2, a detection unit 3, a calculation unit 4, a determination unit 5 and an estimation unit 6. FIG. 2 is a flow chart of a voice processing method by a voice processing device. The voice processing device depicted in FIG. 2 may be the voice processing device 1 depicted in FIG. 1. In the working example 1, the flow of the voice processing by the voice processing device 1 depicted in FIG. 2 is described in an associated relationship with description of functions of the functional block diagram of the voice processing device 1 depicted in FIG. 1.

The acquisition unit 2 is, for example, a hardware circuit configured by hard-wired logic. The acquisition unit 2 may otherwise be a functional module implemented by a computer program executed by the voice processing device 1. The acquisition unit 2 acquires a transmission voice (in other words, a transmitted voice) that is an example of an input voice, for example, through an external apparatus. It is to be noted that the process just described corresponds to step S201 of the flow chart depicted in FIG. 2. The transmission voice means a voice uttered to a second user (which may be referred to as other party) who is a person for conversation with a first user (that may be referred to as oneself) who uses the voice processing device 1. Further, the acquisition unit 2 can acquire a transmission voice, for example, from a microphone (which corresponds to the external apparatus mentioned above), not depicted, coupled to or disposed on the voice processing device 1. Although the transmission voice may be, for example, a voice of the Japanese language, it may otherwise be a voice of a different language such as the English language. In other words, the voice processing in the working example 1 is not language-dependent. The acquisition unit 2 outputs the acquired transmission voice to the detection unit 3.

The detection unit 3 is, for example, a hardware circuit configured by hard-wired logic. The detection unit 3 may otherwise be a functional module implemented by a computer program executed by the voice processing device 1. The detection unit 3 receives a transmission voice from the acquisition unit 2. The detection unit 3 detects a breath temporal segment indicative of an utterance temporal segment (which may be referred to as first utterance temporal segment or voiced temporal segment) included in the transmission voice. It is to be noted that the process just described corresponds to step S202 of the flow chart depicted in FIG. 2. Additionally, the breath temporal segment is, for example, a temporal segment after the first user starts utterance after breath is done during utterance until breath is done again (in other words, a temporal segment between a first breath and a second breath or a temporal segment within which utterance continues). The detection unit 3 detects, for example, an average SNR that is a signal power-to-noise ratio, which is an example of signal quality (which may be referred to as first signal-to-noise ratio), from a plurality of frames included in the transmission voice. Then, the detection unit 3 can detect a temporal segment within which the average SNR satisfies a given condition as an utterance temporal segment (which may be referred to as first utterance temporal segment as described above). Further, the detection unit 3 detects a breath temporal segment indicative of an unvoiced temporal segment continuous to a rear end of an utterance temporal segment included in the transmission voice. The detection unit 3 can detect, for example, a temporal segment within which the average SNR described hereinabove does not satisfy the given condition as an unvoiced temporal segment (in other words, as breath temporal segment).

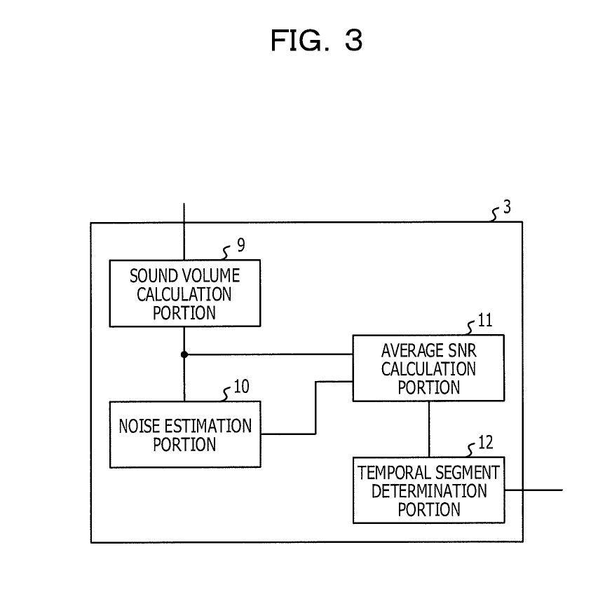

Here, details of the detection process of an utterance temporal segment and an unvoiced temporal segment by a detection unit are described. FIG. 3 is a functional block diagram of a detection unit according to one embodiment. The detection unit may be the detection unit 3 depicted in FIG. 1. The detection unit 3 includes a sound volume calculation portion 9, a noise estimation portion 10, an average SNR calculation portion 11 and a temporal segment determination portion 12. It is to be noted that the detection unit 3 need not necessarily include the sound volume calculation portion 9, the noise estimation portion 10, the average SNR calculation portion 11 and the temporal segment determination portion 12, and the functions the units mentioned have may be implemented by one or more hardware circuits by hard-wired logic. Besides, the functions the units included in the detection unit 3 have may be implemented by a functional module implemented by a computer program executed by the voice processing device 1 in place of a hardware circuit or circuits by hard-wired logic.

Referring to FIG. 3, a transmission voice is inputted to the sound volume calculation portion 9 through the detection unit 3. It is to be noted that the sound volume calculation portion 9 includes a buffer or a cache of a length M not depicted. The sound volume calculation portion 9 calculates the sound volume of each of frames included in the transmission voice and outputs the sound volume to the noise estimation portion 10 and the average SNR calculation portion 11. It is to be noted that the length of each frame included in the transmission voice is, for example, 0.2 msec. The sound volume S(n) of each frame can be calculated using the following expression:

S(n)=Σ_{t=n*M}⁽ⁿ⁺¹⁾*^{M-1}c(t)² (Expression 1)

Here, n is a frame number successively applied to each of the frames beginning with starting of inputting of acoustic frames included in the transmission voice (n is an integer equal to or greater than zero); M a time length of one frame; t time; and c(t) an amplitude (power) of the transmission voice.

The noise estimation portion 10 receives the sound volume S(n) of each frame from the sound volume calculation portion 9. The noise estimation portion 10 estimates noise in each frame and outputs a result of the noise estimation to the average SNR calculation portion 11. Here, the noise estimation of each frame by the noise estimation portion 10 can be performed using, for example, a (noise estimation method 1) or a (noise estimation method 2) described below.

(Noise Estimation Method 1)

The noise estimation portion 10 can estimate the magnitude (power) N(n) of noise in a frame n using the expression given below on the basis of the sound volume S(n) in the frame n, the sound volume S(n−1) in the preceding frame (n−1) and the magnitude N(n−1) of noise.

$$N ( n ) = \{ \begin{matrix}∝ \cdot N ( n - 1 ) + ( 1 - α ) \cdot S ( n ) , & ( where \vert \begin{matrix}S ( n - 1 ) - \\ S ( n )\end{matrix} \vert < β ) \\ N ( n - 1 ) , & ( else )\end{matrix} \qquad ( Expression 2 )$$

Here, α and β are constants, which may be determined experimentally. For example, α and β may be α=0.9 and β=2.0, respectively. Also the initial value N(−1) of the noise power may be determined experimentally. In the (Expression 2) given above, the noise power N(n) of the frame n is updated when the sound volume S(n) of the frame n does not exhibit a variation equal to or greater than the fixed value β from the sound volume S(n−1) of the immediately preceding frame n−1. On the other hand, when the sound volume S(n) of the frame n exhibits a variation equal to or greater than the fixed value β from the sound volume S(n−1) of the immediately preceding frame n−1, the noise power N(n−1) of the immediately preceding frame n−1 is set as the noise power N(n) of the frame n. It is to be noted that the noise power N(n) may be referred to as the noise estimation result described above.

(Noise Estimation Method 2)

The noise estimation portion 10 may perform updating of the magnitude of noise on the basis of the ratio between the sound volume S(n) of the frame n and the noise power N(n−1) of the immediately preceding frame n−1 using the expression (3) given below:

$$N ( n ) = \{ \begin{matrix}∝ \cdot N ( n - 1 ) + ( 1 - α ) \cdot S ( n ) , & ( where S ( n ) < γ \cdot N ( n - 1 ) ) \\ N ( n - 1 ) , & ( else )\end{matrix} \qquad ( Expression 3 )$$

Here, γ is a constant, which may be determined experimentally. For example, γ may be γ=2.0. Also the initial value N(−1) of the noise power may be determined experimentally. If, in the (Expression 3) given above, the sound volume S(n) of the frame n is smaller by γ times the fixed value than the noise power N(n−1) of the immediately preceding frame n−1, then the noise power N(n) of the frame n is updated. On the other hand, if the sound volume S(n) of the frame n is equal to or greater by γ times the fixed value than the noise power N(n−1) of the immediately preceding frame n−1, then the noise power N(n−1) of the immediately preceding frame n−1 is set as the noise power N(n) of the frame n.

Referring to FIG. 3, the average SNR calculation portion 11 receives the sound volume S(n) of each frame from the sound volume calculation portion 9 and receives the noise power N(n) of each frame representative of a noise estimation result from the noise estimation portion 10. It is to be noted that the average SNR calculation portion 11 includes a cache or a memory not depicted and retains the sound volume S(n) and the noise power N(n) for L frames in the past. The average SNR calculation portion 11 calculates the average SNR in an analysis target time period (frames) using the expression given below and outputs the average SNR to the temporal segment determination portion 12.

$$S N R ( n ) = \frac{1}{L} {\sum }_{i = 0}^{L - 1} \frac{S ( n - i )}{N ( n - i )} \qquad ( Expression 4 )$$

Here, L may be set to a value higher than a general length of an assimilated sound and may be set to a number of frames corresponding, for example, to 0.5 msec.

The temporal segment determination portion 12 receives an average SNR from the average SNR calculation portion 11. The temporal segment determination portion 12 includes a buffer or a cache not depicted and retains a flag n_breath indicative of whether or not a pre-processing frame by the temporal segment determination portion 12 is within an utterance temporal segment (in other words, within a breath temporal segment). The temporal segment determination portion 12 detects a start point Ts(n) of an utterance temporal segment using the expression (5) given below and an end point Te(n) of the utterance temporal segment using the expression (6) given below on the basis of the average SNR and the flag n_breath:

Ts(n)=n×M (Expression 5)

(if n_breath=no utterance temporal segment and SNR(n)>TH_{SNR})

Te(n)=n×M−1 (Expression 6)

(if n_breath=utterance temporal segment and SNR(n)<TH_{SNR})

Here, TH_{SNR} is an arbitrary threshold value for regarding that the processed frame n by the temporal segment determination portion 12 does not include noise (the threshold value may be referred to as fifth threshold value (for example, fifth threshold value=12 dB)), and may be set experimentally. It is to be noted that the start point Ts(n) of the utterance temporal segment can be regarded as a sample number at the start point of the utterance temporal segment, and the end point Te(n) can be regarded as a sample number at the end point Te(n) of the utterance temporal segment. Further, the temporal segment determination portion 12 can detect a temporal segment other than utterance temporal segments in a transmission voice as an unvoiced temporal segment.

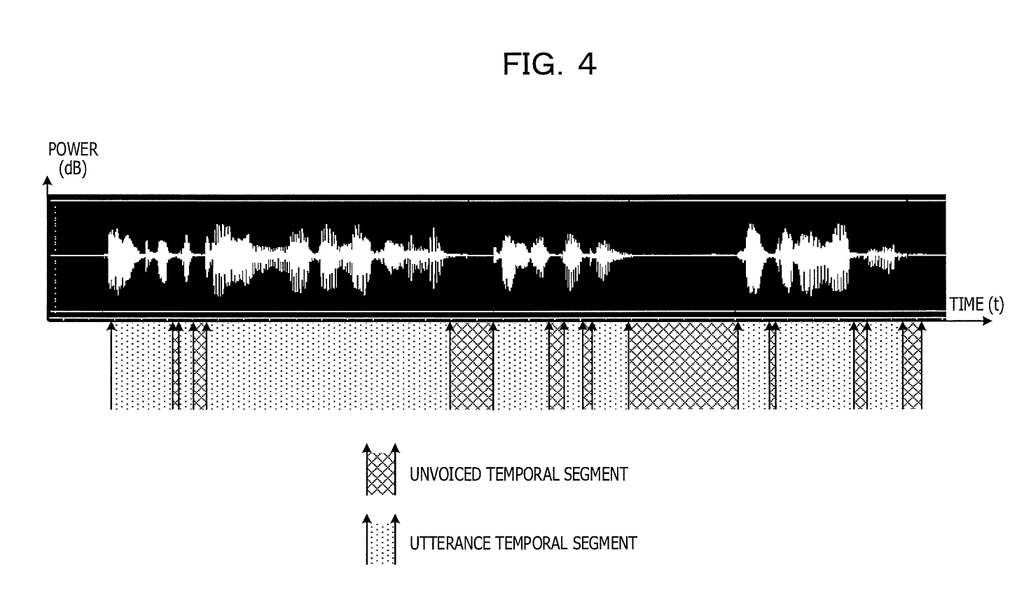

FIG. 4 is a view depicting a result of detection of an utterance temporal segment and an unvoiced temporal segment by a detection unit. The detection unit may be the detection unit 3 depicted in FIG. 1. In FIG. 4, the axis of abscissa indicates time and the axis of ordinate indicates the sound volume (amplitude) of a transmission voice. As depicted in FIG. 4, a temporal segment continuous to the rear end of each utterance temporal segment is detected as an unvoiced temporal segment. Further, as depicted in FIG. 4, in detection of an utterance temporal segment by the detection unit 3 disclosed in the working example 1, noise is learned in accordance with ambient noise, and an utterance temporal segment is discriminated on the basis of the SNR of the learned noise. Therefore, erroneous detection of an utterance temporal segment caused by ambient noise can be prevented. Further, since the average SNR is determined from a plurality of frames, there is an advantage that, even if a period of time in which no voice is included appears instantaneously within an utterance temporal segment, the period of time can be extracted as a continuous utterance temporal segment. It is to be noted that also it is possible for the detection unit 3 to use the method disclosed in International Publication Pamphlet No. WO 2009/145192. The detection unit 3 outputs the detected utterance temporal segment to the calculation unit 4.

Referring to FIG. 1, the calculation unit 4 is, for example, a hardware circuit configured by hard-wired logic. The calculation unit 4 may alternatively be a functional module implemented by a computer program executed by the voice processing device 1. The calculation unit 4 receives an utterance temporal segment detected by the detection unit 3 from the detection unit 3. The calculation unit 4 calculates a first feature value in the utterance temporal segment. It is to be noted that the process just described corresponds to step S203 of the flow chart depicted in FIG. 2. Further, the first feature value is, for example, a temporal segment length of the utterance temporal segment or a number of vowels included in the utterance temporal segment.

The calculation unit 4 calculates the temporal segment length L(n) of an utterance temporal segment, which is an example of the first feature value, from a start point and an end point of the utterance temporal segment using the following expression:

L(n)=Te(n)−Ts(n) (Expression 7)

It is to be noted that, in the (Expression 7) above, Ts(n) is a sample number at the start point of the utterance temporal segment, and Te(n) is a sample number at an end point of the utterance temporal segment. It is to be noted that Ts(n) and Te(n) can be calculated using the (Expression 5) and the (Expression 6) given hereinabove, respectively. Further, the calculation unit 4 detects the number of vowels within an utterance temporal segment, which is an example of the first feature value, for example, from a Formant distribution. The calculation unit 4 can use, as the detection method of the number of vowels based on a Formant distribution, the method disclosed, for example, in Japanese Laid-open Patent Publication No. 2009-258366. The calculation unit 4 outputs the calculated first feature value to the determination unit 5.

The determination unit 5 is, for example, a hardware circuit configured by hard-wired logic. In addition, the determination unit 5 may be a functional module implemented by a computer program executed by the voice processing device 1. The determination unit 5 receives a first feature value from the calculation unit 4. The determination unit 5 determines a frequency of appearance of a second feature value, with which the first feature value is smaller than a given first threshold value, in a transmission voice. In other words, the determination unit 5 determines a frequency that a second feature value appears in a transmission voice as a response (back-channel feedback) to an utterance of a reception voice (in other words, a received voice). In still other words, on the basis of the first feature value, the determination unit 5 determines a frequency that a second feature value appearing in a transmission voice as a response to understanding of a reception voice appears in the transmission voice within an utterance temporal segment of the reception voice (the utterance temporal segment may be referred to as second utterance temporal segment). It is to be noted that the process just described corresponds to step S204 of the flow chart depicted in FIG. 2. Further, the first threshold value is an arbitrary second threshold value for a temporal segment length of the utterance temporal segment (for example, the second threshold value=2 seconds) or an arbitrary third threshold value for the number of vowels in an utterance temporal segment (for example, the third threshold value=4). For example, when the condition of one of the second threshold value and the third threshold value is satisfied, the determination unit 5 can determine that the condition of the first threshold value is satisfied. Further, when both conditions of the second threshold value and the third threshold value are satisfied, the determination unit 5 can determine that the condition of the first threshold value is satisfied. When the temporal segment length of one utterance temporal segment is smaller than the arbitrary second threshold value or the number of vowels in one utterance temporal segment is smaller than the arbitrary third threshold value, the determination unit 5 determines that the second feature value appears. In other words, the frequency of the second feature value is a feature value that is handled as a number of back-channel feedbacks. Since the back-channel feedbacks are interjections such as, for example, “yes,” “no,” “year,” “really?” and “that's right,” appearing in conversations, the back-channel feedbacks include characteristics that the temporal segment length of the back-channel feedbacks is short in comparison with the temporal segment length of ordinary utterances and also that the number of vowels is small. Therefore, the determination unit 5 can determine a frequency of appearance of a second feature value corresponding to a back-channel feedback by using the second and third threshold values described above.

Further, the determination unit 5 may recognize a transmission voice as a character string and determine a number of times of appearance by which a given word corresponding to the second feature value appears as a frequency of appearance of the second feature value from the character string. The determination unit 5 can apply, as the method for recognizing a transmission voice as a character string, the method disclosed, for example, in Japanese Laid-open Patent Publication No. 04-255900. Further, such given words are words that correspond to back-channel feedbacks stored in a word list (table) written in a cache or a memory not depicted provided in the determination unit 5. The given words may be words that generally correspond to back-channel feedbacks such as, for example, “yes,” “no,” “year,” “really?” and “that's right.”

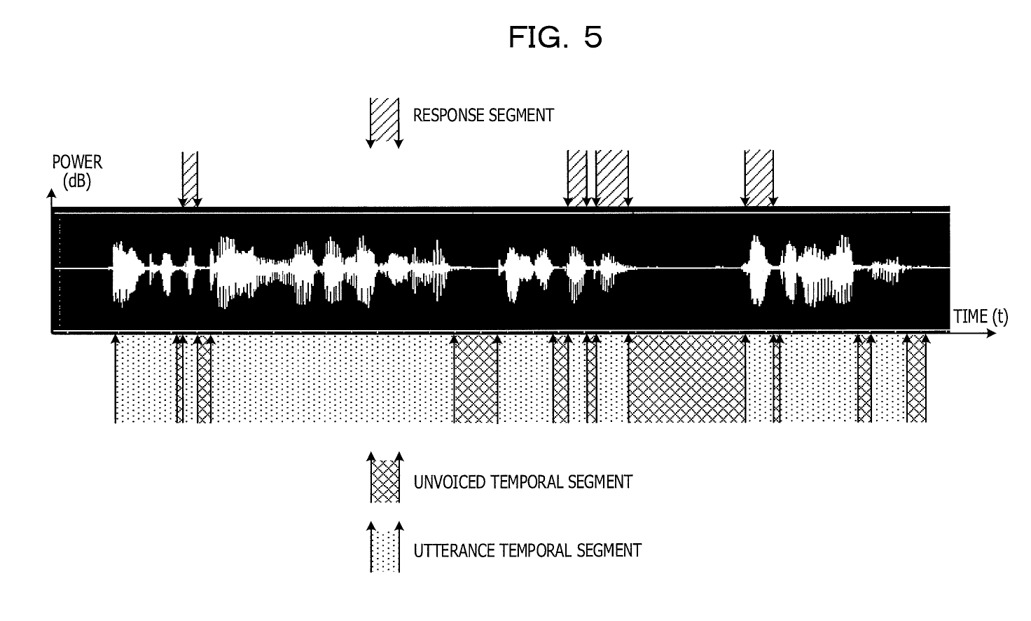

FIG. 5 is a view depicting a result of determination of appearance of a response segment by a determination unit. The determination unit may be the determination unit 5 depicted in FIG. 1. FIG. 5 depicts a detection result of an utterance temporal segment and an unvoiced temporal segment. In FIG. 5, the axis of abscissa indicates time and the axis of ordinate indicates the sound volume (amplitude) of a transmission voice similarly as in FIG. 4. As depicted in FIG. 5, a temporal segment within which the second threshold value and the third threshold value are satisfied from within an utterance temporal segment is determined as a response segment.

Then, the determination unit 5 determines a number of times of appearance of the second feature value per unit time period as a frequency. The determination unit 5 can calculate the number of times of appearance of the second feature value corresponding to a back-channel feedback, for example, per one minute as a frequency freq(t) using the following expression:

$$freq ( t ) = {\sum }_{t < Ts ( n ) < t + 60} sgn [ L ( n ) ] \vert L ( n ) \leq TH 2 orTH 3 \qquad ( Expression 8 )$$

It is to be noted that, in the (Expression 8) above, L(n) is a temporal segment length of the utterance temporal segment; Ts(n) is a sample number at the start point of the utterance temporal segment; TH2 is the second threshold value; and TH3 is the third threshold value.

When the determination unit 5 recognizes the above-described transmission voice as a character string and determines the number of times of appearance by which a given word corresponding to the second feature value appears from the character string, the determination unit 5 may utilize an appearance interval of the second feature value per unit time period as a frequency. The determination unit 5 can calculate an average time interval after which the second feature value corresponding to a back-channel feedback appears, for example, per one minute as the frequency freq′(t) using the following expression:

$${freq}^{′} ( t ) = {ave}_{t < Ts ( n ) < t + 60} ( {Te}^{′} ( n ) - {Ts}^{′} ( n - 1 ) ) \qquad ( Expression 9 )$$

It is to be noted that, in the (Expression 9) above, Ts′(n) is a sample number at the start point of a second feature value temporal segment, and Te′(n) is a sample number at the end point of the second feature value temporal segment.

Furthermore, the determination unit 5 may determine a ratio of the number of times of appearance of the second feature value to the temporal segment number of utterance temporal segments as a frequency. In other words, the determination unit 5 can calculate the frequency freq″(t) in which the second feature value appears in accordance with the following expression using the number of times of appearance of an utterance temporal segments and the number of times of appearance of the second feature value corresponding to a back-channel feedback, for example, per one minute:

$${freq}^{″} ( t ) = \frac{{\sum }_{t < Ts ( n ) < t + 60} sgn [ NV ( n ) ] \vert NV ( n ) \leq TH 2 orTH 3}{{\sum }_{t < Ts ( n ) < t + 60} sgn [ L ( n ) ]} \qquad ( Expression 10 )$$

It is to be noted that, in the (Expression 10) above, L(n) is a temporal segment length of the utterance temporal segment; Ts(n) is the sample number at the start point of the utterance temporal segment; NV(n) is the second feature value; TH2 is the second threshold value; and TH3 is the third threshold value. The determination unit 5 outputs the determined frequency to the estimation unit 6.

The estimation unit 6 is, for example, a hardware circuit configured by hard-wired logic. Besides, the estimation unit 6 may be a functional module implemented by a computer program executed by the voice processing device 1. The estimation unit 6 receives a frequency from the determination unit 5. The estimation unit 6 estimates an utterance time period of the reception voice (second user) on the basis of the frequency. It is to be noted that the process just described corresponds to step S205 of the flow chart depicted in FIG. 2.

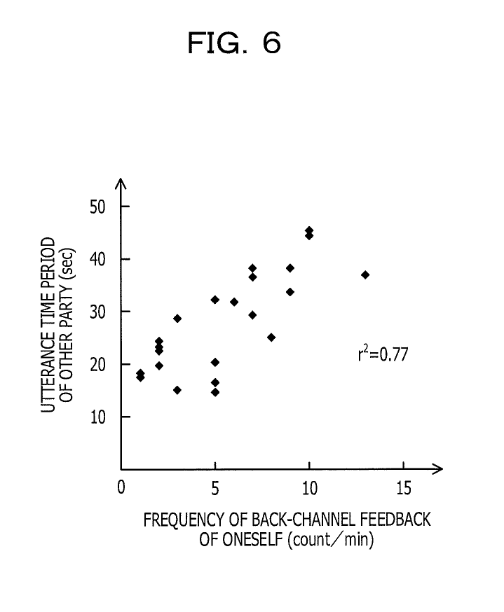

Here, a technological significance of an estimation of an utterance time period of a reception voice on the basis of a frequency in the working example 1 is described. As a result of intensive verification of the inventors of the present technology, the technological matters described below became apparent. The inventors paid attention to the presence of the nature that, while a second user (other party) is talking, a first user (oneself) performs a back-channel feedback behavior, and newly performed intensive verification of the possibility that it may be able to estimate an utterance time period of the other party (which may be referred to as utterance time period of a reception voice) making use of the frequency of the back-channel feedback of the first user. FIG. 6 is a diagram depicting a relationship between a frequency of a back-channel feedback of a first user and an utterance time period of a second user. In FIG. 6, a correlation between the frequency of the back-channel feedback per a unit time period (one minute) included in a voice of a first user (oneself) and the utterance time period of a second user (other party) when a plurality of test subjects (11 persons) talk with one another for two minutes is depicted. It is to be noted that bubble-like noise (SNR=0 dB) is overlapped with an utterance voice of the second voice that becomes a reception voice to the first user, thereby reproducing an existence of ambient noise.

As depicted in FIG. 6, the correlation coefficient r² between the frequency of the back-channel feedback and the utterance time period of the second user (other party) per unit time period (one minute) included in the voice of the first user (oneself) is 0.77, and it became clear that the frequency of the back-channel feedback and the utterance time period include a strong correlation therebetween. It is to be noted that, as a comparative example, also a correlation between an unvoiced temporal segment within which the first user (oneself) does not talk and an utterance temporal segment of the second user (other party) was investigated. The investigation made it clear that the unvoiced temporal segment and the utterance temporal segment mentioned do not include a sufficient correlation. It is inferred that such an insufficient correlation as just described arises from the fact that there is no guarantee that, when oneself is not talking, the other party is uttering without fail and there is a case in which any of oneself and the other party is not talking. An example of the case just mentioned is that, for example, both of oneself and the other party are confirming the contents of a document with each other. On the other hand, a back-channel feedback is an interjection for representing that the contents of an utterance of the other party are understood, and it is inferred that a back-channel feedback includes a strong correlation to the utterance time period of the other party because it includes the nature that, when the other party does not utter, the back-channel feedback does not occur. Therefore, it became apparent through intensive verification of the inventors of the present technology that, if a reception voice is estimated on the basis of a frequency that the second feature value corresponding to a back-channel feedback appears, then since the back-channel feedback does not rely upon the signal quality of the reception voice of the other party, it is possible to estimate the utterance time period of the reception voice without depending upon ambient noise. Further, since the detection unit 3 detects also an utterance temporal segment within which oneself utters, also it is possible to distinctly detect a situation in which oneself is uttering unilaterally and another situation in which oneself listens to the utterance of the other party while oneself is uttering.

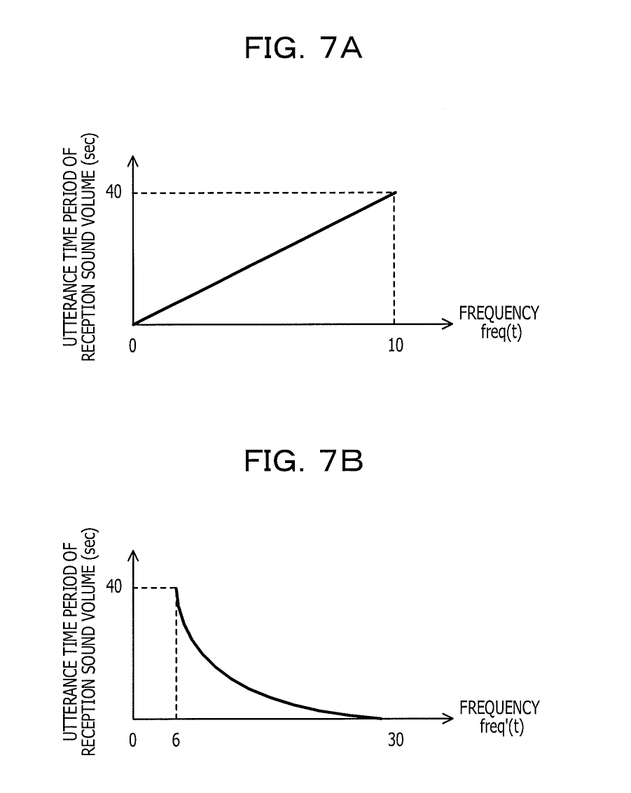

The estimation unit 6 estimates the utterance time period of a reception voice on the basis of a first correlation between the frequency and the utterance time period determined in advance. It is to be noted that the first correlation can be suitably set experimentally on the basis of, for example, the correlation depicted in FIG. 6. FIG. 7A is a diagram depicting a first relationship between a frequency and an estimated utterance time period of a reception voice. In FIG. 7A, the axis of abscissa indicates the frequency freq(t) calculated using the (Expression 8) given hereinabove, and the axis of ordinate indicates the estimated utterance time period of a reception voice. FIG. 7B is a diagram depicting a second relationship between a frequency and an estimated utterance time period of a reception voice. In FIG. 7B, the axis of abscissa indicates the frequency freq′(t) calculated using the (Expression 9) given hereinabove and the axis of ordinate indicates the estimated utterance time period of a reception voice. The estimation unit 6 uses the diagram of the first relationship or the diagram of the second relationship as a first correlation to estimate the utterance time period of the reception voice corresponding to the frequency.

Besides, when the total value of the temporal segment length of the utterance temporal segments is lower than a fourth threshold value (for example, the fourth threshold value=15 sec), the estimation unit 6 may estimate the utterance time period of the reception voice on the basis of the frequency and a second correlation with which the utterance time period of a reception voice is set shorter than the utterance time period of a reception voice with the first correlation described hereinabove. The estimation unit 6 calculates the total value TL1(t) of the temporal segment length of the utterance temporal segments per unit time period (for example, per one minute) using the following expression:

TL1(t)=Σ_{t<Ts(n)<t+60}L(n) (Expression 11)

It is to be noted that, in the (Expression 11) above, L(n) is a temporal segment length of an utterance temporal segment, and Ts(n) is a sample number at the start point of the utterance temporal segment.

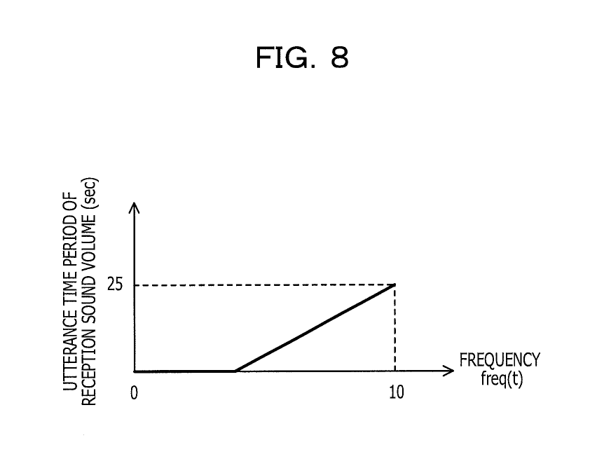

FIG. 8 is a diagram depicting a third relationship between a frequency and an estimated utterance time period of a reception voice. In FIG. 8, the axis of abscissa indicates the frequency freq(t) calculated using the (Expression 8) given hereinabove and the axis of ordinate indicates the estimated utterance time period of a reception voice. The estimation unit 6 uses the diagram of the third relationship as a second correlation to estimate the utterance time period of a reception voice corresponding to the frequency. If the total value TL1(t) calculated by the estimation unit 6 using the (Expression 11) given above is lower than a fourth threshold value (for example, the fourth threshold value=15 sec), then the estimation unit 6 estimates the utterance time period of the reception voice using the second correlation indicated by the diagram of the third relationship. Since the estimation unit 6 estimates the utterance time period of a reception voice on the basis of the second correlation, when any of the first user (oneself) and the second user (other party) is not taking (is silent), the influence that the frequency of the back-channel feedback is low can be reduced.

The estimation unit 6 outputs an estimated utterance time period of a reception voice to an external apparatus. It is to be noted that the process just described corresponds to step S206 of the flow chart depicted in FIG. 2. Further, the external apparatus may be, for example, a speaker that reproduces the utterance time period of the reception voice after conversion into voice or a display unit that displays the utterance time period as character information. Besides, the estimation unit 6 may transmit a given control signal to the external apparatus on the basis of the ratio between the utterance time period of the reception voice (the utterance time period may be referred to as second utterance temporal segment) and the total value of the utterance temporal segments of the transmission voice (the total value may be referred to as first utterance temporal segment). It is to be noted that, when the process just described is to be performed, the process may be performed together with step S206 of the flow chart depicted in FIG. 2. The control signal may be, for example, alarm sound. The estimation unit 6 calculates the ratio R(t) between the utterance time period TL2(t) of the reception voice and the total value TL1(t) of the utterance temporal segments of the transmission voice per unit time period (for example, per one minute) using the following expression:

R(t)=TL2(t)/TL1(t) (Expression 12)

It is to be noted that, in the (Expression 12) above, TL1(t) can be calculated using the (Expression 11) given hereinabove and TL2(t) can be calculated using a method similar to the method for TL1(t), and therefore, detailed descriptions of TL1(t) and TL2(t) are omitted herein.

The estimation unit 6 originates a control signal on the basis of comparison represented by the following expression between the ratio R(t) calculated using the (Expression 12) given above and a given sixth threshold value (for example, the sixth threshold value=0.5):

If R(t)<TH5CS(t)=1(control signal originated)

elseCS(t)=0(control signal not originated) (Expression 13)

With the voice processing device according to the working example 1, the utterance time period of a reception voice can be estimated without relying upon ambient noise.

### Working Example 2

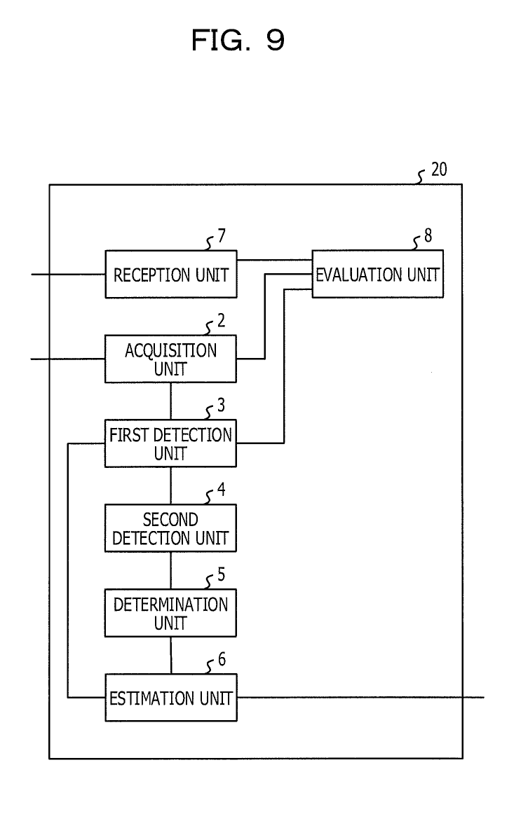

FIG. 9 is a functional block diagram of a voice processing device according to a second embodiment. A voice processing device 20 includes an acquisition unit 2, a detection unit 3, a calculation unit 4, a determination unit 5, an estimation unit 6, a reception unit 7 and an evaluation unit 8. The acquisition unit 2, the detection unit 3, the calculation unit 4, the determination unit 5 and the estimation unit 6 include functions similar to the functions at least disclosed through the working example 1, and therefore, detailed descriptions of the acquisition unit 2, the detection unit 3, the calculation unit 4, the determination unit 5 and the estimation unit 6 are omitted herein.

The reception unit 7 is, for example, a hardware circuit configured by hard-wired logic. Besides, the reception unit 7 may be a functional module implemented by a computer program executed by the voice processing device 20. The reception unit 7 receives a reception voice, which is an example of an input voice, for example, through a wired circuit or a wireless circuit. The reception unit 7 outputs the received reception voice to the evaluation unit 8.

The evaluation unit 8 receives a reception voice from the reception unit 7. The evaluation unit 8 evaluates a second signal-to-noise ratio of the reception voice. The evaluation unit 8 can apply, as an evaluation method of a second signal-to-noise ratio, a technique similar to the technique for detection of the first signal-to-noise ratio by the detection unit 3 in the working example 1. The evaluation unit 8 evaluates an average SNR that is an example of the second signal-to-noise ratio, for example, using the (Expression 4) given hereinabove. If the average SNR that is an example of the second signal-to-noise ratio is lower than a given seventh threshold value (for example, the seventh threshold value=10 dB), then the evaluation unit 8 issues an instruction to carry out a voice processing method on the basis of the working example 1 to the acquisition unit 2. In other words, the acquisition unit 2 determines whether or not a transmission voice is to be acquired on the basis of the second signal-to-noise ratio. On the other hand, if the average SNR that is an example of the second signal-to-noise ratio is equal to or higher than the seventh threshold value, then the evaluation unit 8 outputs the reception voice to the detection unit 3 so that the detection unit 3 detects the utterance temporal segment of the reception voice (the utterance temporal segment may be referred to as second utterance temporal segment). It is to be noted that, as the detection method for an utterance temporal segment of the reception voice, the detection method of a first utterance temporal segment disclosed through the working example 1 can be used similarly, and therefore, detailed description of the detection method is omitted herein. The detection unit 3 outputs the detected utterance temporal segment of the reception voice (second utterance temporal segment) to the estimation unit 6.

The estimation unit 6 uses the utterance time period L of the reception voice estimated by the method disclosed through the working example 1 to estimate a central temporal segment [Ts2, Te2] within a temporal segment [Ts1, Te1] within which the second feature value per unit time period appears as the utterance temporal segment of the reception voice. It is to be noted that the central temporal segment [Ts2, Te2] can be calculated using the following expression:

Ts2=(Ts1+Te1)/2−L/2 (Expression 14)

Tet=(Ts1+Te1)/2+L/2

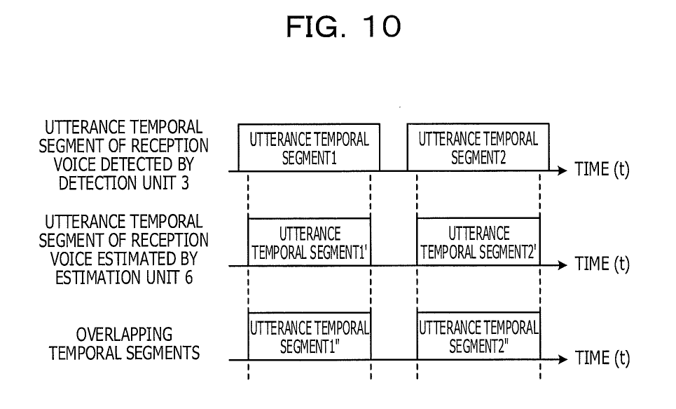

FIG. 10 is a conceptual diagram of an overlapping temporal segment within an utterance temporal segment of a reception voice. In FIG. 10, an utterance temporal segment (utterance temporal segment 1 and utterance temporal segment 2) of a reception voice detected by the detection unit 3 and an utterance temporal segment (utterance temporal segment 1′ and utterance temporal segment 2′) of the reception voice estimated using the (Expression 14) above are indicated. The estimation unit 6 estimates a temporal segment within which the utterance temporal segment 1 and the utterance temporal segment 1′ overlap and another temporal segment within which the utterance temporal segment 2 and the utterance temporal segment 2′ overlap as overlapping temporal segments (utterance temporal segment 1″ and utterance temporal segment 2″). An evaluator evaluated the degree of coincidence indicating whether or not the second user is actually uttering within an utterance temporal segment of a reception voice detected by the detection unit 3. The evaluation indicates a degree of coincidence of approximately 40%. On the other hand, the degree of coincidence in the overlapping temporal segments is 49%, and it was successfully verified that the estimation accuracy in the utterance temporal segments of the reception voice is improved.

With the voice processing device according to the working example 2, it is possible to estimate an utterance time period of a reception voice in accordance with signal quality of the reception voice without relying upon ambient noise. Further, with the voice processing device according to the working example 2, it is possible to estimate an utterance temporal segment of a reception voice.

### Working Example 3

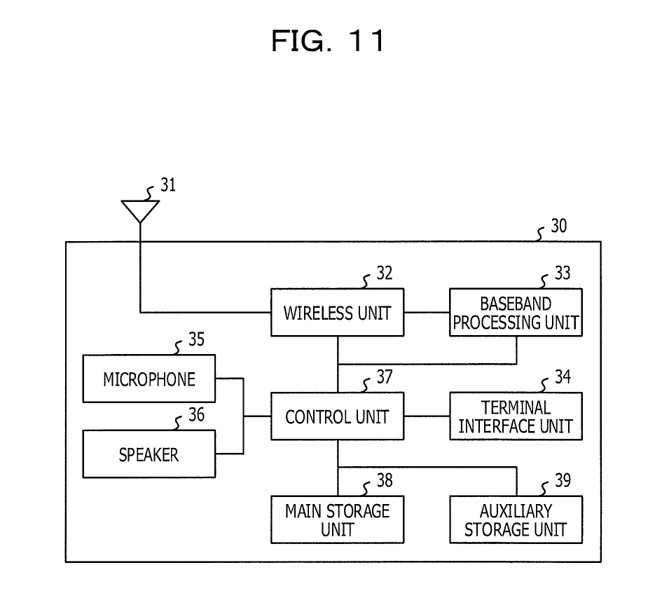

FIG. 11 is a block diagram depicting a hardware configuration that functions as a portable terminal device according to one embodiment. A portable terminal device 30 includes an antenna 31, a wireless unit 32, a baseband processing unit 33, a terminal interface unit 34, a microphone 35, a speaker 36, a control unit 37, a main storage unit 38 and an auxiliary storage unit 39.

The antenna 31 transmits a wireless signal amplified by a transmission amplifier and receives a wireless signal from a base station. The wireless unit 32 digital-to-analog converts a transmission signal spread by the baseband processing unit 33, converts a resulting analog transmission signal into a high frequency signal by orthogonal transformation and amplifies the high frequency signal by a power amplifier. The wireless unit 32 amplifies a received wireless signal, analog-to-digital converts the amplified signal and transmits a resulting digital signal to the baseband processing unit 33.

The baseband processing unit 33 performs baseband processes such as error correction coding of transmission data, data modulation, determination of a reception signal and a reception environment, threshold value determination for channel signals and error correction decoding.

The control unit 37 is, for example, a Central Processing Unit (CPU), a Micro Processing Unit (MPU), a Digital Signal Processor (DSP), an Application Specific Integrated Circuit (ASIC) or a Programmable Logic Device (PLD). The control unit 37 performs wireless control such as transmission and reception of a control signal. Further, the control unit 37 executes a voice processing program stored in the auxiliary storage unit 39 or the like and performs, for example, the voice processes in the working example 1 or the working example 2. In other words, the control unit 37 can execute processing of the functional blocks such as, for example, the acquisition unit 2, the detection unit 3, the calculation unit 4, the determination unit 5, the estimation unit 6, the reception unit 7 and the evaluation unit 8 depicted in FIG. 1 or FIG. 9.

The main storage unit 38 is a Read Only Memory (ROM), a Random Access Memory (RAM) or the like and is a storage device that stores or temporarily retains data and programs such as an Operating System (OS), which is basic software, and application software that are executed by the control unit 37.

The auxiliary storage unit 39 is a Hard Disk Drive (HDD), a Solid State Drive (SSD) or the like and is a storage device for storing data relating to application software or the like.

The terminal interface unit 34 performs adapter processing for data and interface processing with a handset and an external data terminal.

The microphone 35 receives a voice of an utterer (for example, a first user) as an input thereto and outputs the voice as a microphone signal to the control unit 37. The speaker 36 outputs a signal outputted from the control unit 37 as an output voice or a control signal.

### Working Example 4

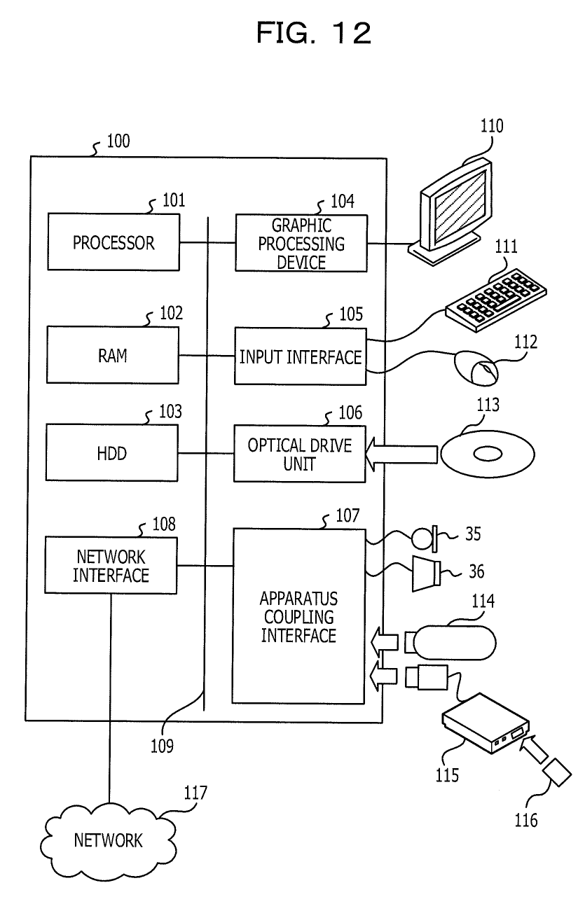

FIG. 12 is a block diagram depicting a hardware configuration of a computer that functions as a voice processing device according to one embodiment. The voice processing device depicted in FIG. 12 may be the voice processing device 1 depicted in FIG. 1. As depicted in FIG. 12, the voice processing device 1 includes a computer 100 and inputting and outputting apparatuses (peripheral apparatus) coupled to the computer 100.

The computer 100 is controlled entirely by a processor 101. To the processor 101, a RAM 102 and a plurality of peripheral apparatuses are coupled through a bus 109. It is to be noted that the processor 101 may be a multiprocessor. Further, the processor 101 is, for example, a CPU, an MPU, a DSP, an ASIC or a PLD. Further, the processor 101 may be a combination of two or more of a CPU, an MPU, a DSP, an ASIC and a PLD. It is to be noted that, for example, the processor 101 may execute processes of functional blocks such as the acquisition unit 2, the detection unit 3, the calculation unit 4, the determination unit 5, the estimation unit 6, the reception unit 7 and the evaluation unit 8 depicted in FIG. 1 or FIG. 9.

The RAM 102 is used as a main memory of the computer 100. The RAM 102 temporarily stores at least part of a program of an OS and application programs to be executed by the processor 101. Further, the RAM 102 stores various data to be used for processing by the processor 101. The peripheral apparatuses coupled to the bus 109 include an HDD 103, a graphic processing device 104, an input interface 105, an optical drive unit 106, an apparatus coupling interface 107 and a network interface 108.

The HDD 103 performs writing and reading out of data magnetically on and from a disk built in the HDD 103. The HDD 103 is used, for example, as an auxiliary storage device of the computer 100. The HDD 103 stores a program of an OS, application programs and various data. It is to be noted that also a semiconductor storage device such as a flash memory can be used as an auxiliary storage device.

A monitor 110 is coupled to the graphic processing device 104. The graphic processing device 104 controls the monitor 110 to display various images on a screen in accordance with an instruction from the processor 101. The monitor 110 may be a display unit that uses a Cathode Ray Tube (CRT), a liquid crystal display unit or the like.

To the input interface 105, a keyboard 111 and a mouse 112 are coupled. The input interface 105 transmits a signal sent thereto from the keyboard 111 or the mouse 112 to the processor 101. It is to be noted that the mouse 112 is an example of a pointing device and also it is possible to use a different pointing device. As the different pointing device, a touch panel, a tablet, a touch pad, a track ball and so forth are available.

The optical drive unit 106 performs reading out of data recorded on an optical disc 113 utilizing a laser beam or the like. The optical disc 113 is a portable recording medium on which data are recorded so as to be read by reflection of light. As the optical disc 113, a Digital Versatile Disc (DVD), a DVD-RAM, a Compact Disc Read Only Memory (CD-ROM), a CD-R (Recordable)/RW (ReWritable) and so forth are available. A program stored on the optical disc 113 serving as a portable recording medium is installed into the voice processing device 1 through the optical drive unit 106. The given program installed in this manner is enabled for execution by the voice processing device 1.

The apparatus coupling interface 107 is a communication interface for coupling a peripheral apparatus to the computer 100. For example, a memory device 114 or a memory reader-writer 115 can be coupled to the apparatus coupling interface 107. The memory device 114 is a recording medium that incorporates a communication function with the apparatus coupling interface 107. The memory reader-writer 115 is an apparatus that performs writing of data into a memory card 116 and reading out of data from the memory card 116. The memory card 116 is a card type recording medium. To the apparatus coupling interface 107, a microphone 35 and a speaker 36 can be coupled further.

The network interface 108 is coupled to a network 117. The network interface 108 performs transmission and reception of data to and from a different computer or a communication apparatus through the network 117.

The computer 100 implements the voice processing function described hereinabove by executing a program recorded, for example, on a computer-readable recording medium. A program that describes the contents of processing to be executed by the computer 100 can be recorded on various recording media. The program can be configured from one or a plurality of functional modules. For example, the program can be configured from functional modules that implement the processes of the acquisition unit 2, the detection unit 3, the calculation unit 4, the determination unit 5, the estimation unit 6, the reception unit 7, the evaluation unit 8 and so forth depicted in FIG. 1 or FIG. 9. It is to be noted that the program to be executed by the computer 100 can be stored in the HDD 103. The processor 101 loads at least part of the program in the HDD 103 into the RAM 102 and executes the program. Also it is possible to record a program, which is to be executed by the computer 100, in a portable recording medium such as the optical disc 113, memory device 114 or memory card 116. A program stored in a portable recording medium is installed into the HDD 103 and then enabled for execution, for example, under the control of the processor 101. Also it is possible for the processor 101 to directly read out a program from a portable recording medium and then execute the program.

The components of the devices and the apparatus depicted in the figures need not necessarily be configured physically in such a manner as depicted in the figures. In particular, the particular form of integration or disintegration of the devices and apparatus is not limited to that depicted in the figures, and all or part of the devices and apparatus can be configured in a functionally or physically integrated or disintegrated manner in an arbitrary unit in accordance with loads, use situations and so forth of the devices and apparatus. Further, the various processes described in the foregoing description of the working examples can be implemented by execution of a program prepared in advance by a computer such as a personal computer or a work station.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A voice processing device comprising:
a memory; and
a processor configured to execute a plurality of instructions stored in the memory, the instructions comprising:
acquiring a transmitted voice;
first detecting a first utterance segment of the transmitted voice;
second detecting a response segment from the first utterance segment;
determining a frequency of the response segment included in the transmitted voice; and
estimating an utterance time period of a received voice on a basis of the frequency.

2. The device according to claim 1,
wherein the second detecting detects the first utterance segment as the response segment, when the segment length of the first utterance segment is smaller than a predetermined threshold value.

3. The device according to claim 1,
wherein the second detecting detects the first utterance segment as the response segment, when the vowel number in the first utterance segment is smaller than a predetermined threshold value.

4. The device according to claim 1,
wherein the second detecting recognizes the transmitted voice as a character strings and detects the first utterance segment as the response segment, when the character strings include a predetermined word.

5. The device according to claim 1,
wherein the determining determines a number of times of appearance of the response segment per a unit time period and/or an appearance interval of the response segment per the unit time period as the frequency.

6. The device according to claim 1,
wherein the determining determines a ratio of a number of times of appearance of the response segment to a segment number of the first utterance segment as the frequency.

7. The device according to claim 1,
wherein the estimating estimates the utterance time period on a basis of a predetermined first correlation between the frequency and the utterance time period; and
wherein, when a total value of segment lengths of the first utterance segments is lower than a predetermined threshold value, the estimating estimates the utterance time period on a basis of a second correlation in which the utterance time period is determined shorter than the utterance time period of the first correlation.

8. The device according to claim 1,
wherein the estimating originates a predetermined control signal on a basis of a ratio between the utterance time period of the received voice and the total value of the first utterance segments.

9. The device according to claim 1,
wherein the first detecting detects a first signal-to-noise ratio of a plurality of frames included in the transmitted voice and detects the frames in which the first signal-to-noise ratio is equal to or higher than a predetermined threshold value as the first utterance segment.

10. The device according to claim 1,
wherein the first detecting further detects a second utterance segment of the received voice; and
wherein the estimating estimates an utterance segment of the received voice on a basis of the frequency of the response segment and the second utterance segment.

11. The device according to claim 10, further comprising:
receiving the received voice; and
evaluating a second signal-to-noise ratio of the received voice;
wherein the estimating estimates an utterance segment of the received voice on a basis of the frequency of the response segment, when the second signal-to-noise ratio is higher than a predetermined threshold value, and estimates an utterance segment of the received voice on a basis of the second utterance segment, when the second signal-to-noise ratio is smaller than the predetermined threshold value.

12. A voice processing method, comprising:
acquiring a transmitted voice;
first detecting a first utterance segment of the transmitted voice;
second detecting a response segment from the first utterance segment;
determining, by a computer processor, a frequency of the response segment included in the transmitted voice; and
estimating an utterance time period of a received voice on a basis of the frequency.

13. The method according to claim 12,
wherein the second detecting detects the first utterance segment as the response segment, when the segment length of the first utterance segment is smaller than a predetermined threshold value.

14. The method according to claim 12,
wherein the second detecting detects the first utterance segment as the response segment, when the vowel number in the first utterance segment is smaller than a predetermined threshold value.

15. The device according to claim 12,
wherein the second detecting recognizes the transmitted voice as a character strings and detects the first utterance segment as the response segment, when the character strings include a predetermined word.

16. The method according to claim 12,
wherein the determining determines a number of times of appearance of the response segment per a unit time period or an appearance interval of the response segment per the unit time period as the frequency.

17. The method according to claim 12,
wherein the determining determines a ratio of a number of times of appearance of the response segment to a segment number of the first utterance segment as the frequency.

18. The method according to claim 12,
wherein the estimating estimates the utterance time period on a basis of a predetermined first correlation between the frequency and the utterance time period; and
wherein, when a total value of segment lengths of the first utterance segments is lower than a predetermined threshold value, the estimating estimates the utterance time period on a basis of a second correlation in which the utterance time period is determined shorter than the utterance time period of the first correlation.

19. The method according to claim 12,
wherein the estimating originates a predetermined control signal on a basis of a ratio between the utterance time period of the received voice and the total value of the first utterance segments.

20. The method according to claim 12,
wherein the first detecting detects a first signal-to-noise ratio of a plurality of frames included in the transmitted voice and detects the frames in which the first signal-to-noise ratio is equal to or higher than a predetermined threshold value as the first utterance segment.

21. The method according to claim 12,
wherein the first detecting further detects a second utterance segment of the received voice; and
wherein the estimating estimates an utterance segment of the received voice on a basis of the frequency of the response segment and the second utterance segment.

22. The method according to claim 12, further comprising:
receiving the received voice; and
evaluating a second signal-to-noise ratio of the received voice;
wherein the estimating estimates an utterance segment of the received voice on a basis of the frequency of the response segment, when the second signal-to-noise ratio is higher than a predetermined threshold value, and estimates an utterance segment of the received voice on a basis of the second utterance segment, when the second signal-to-noise ratio is smaller than the predetermined threshold value.

23. A computer-readable non-transitory medium that stores a voice processing program for causing a computer to execute a process comprising:
acquiring a transmitted voice;
first detecting a first utterance segment of the transmitted voice;
second detecting a response segment from the first utterance segment;
determining a frequency of the response segment included in the transmitted voice; and
estimating an utterance time period of a received voice on a basis of the frequency.
